(19) United States
(12) Patent Application Publication
(10) Pub. No.: US 2011/0125917 A1
(43) Pub. Date: May 26, 2011

(54) OVERLAY MULTICAST SYSTEM FOR GROUP MEDIA TRANSMISSION APPLICATION SERVICE COMPOSED OF MULTIPLE STREAM

(75) Inventors: Kyunghun KIM, Gwangju (KR); Nac Woo KIM, Gwangju (KR); Byung-Tak LEE, Gyeonggi-do (KR); Seung-Hun OH, Gwangju (KR); Jai Sang KOH, Gwangju (KR)

(73) Assignee: Electronics and Telecommunications Reseach Institute, Daejeon (KR)

(21) Appl. No.: 12/652,111

(22) Filed: Jan. 5, 2010

(30) Foreign Application Priority Data
Nov. 20, 2009 (KR) 10-2009-0112351

(51) Int. Cl. G06F 15/16

(52) U.S. Cl. 709/231

(57) ABSTRACT

Disclosed is an overlay multicast system for a group media transmission application service composed of a multiple stream, wherein, when an additional stream is newly transferred to a predetermined node in an overlay network, the overlay multicast system transmitting a plurality of streams in the overlay network generates a multiple stream by muxing a main stream inputted from a parent node and the additional stream based on stream correlation information in the predetermined node, and transmits the generated multiple stream to a child node.

### CROSS-REFERENCE TO RELATED APPLICATION

This application claims the benefit of Korean Patent Application No. 10-2009-0112351, filed on Nov. 20, 2009, in the Korean Intellectual Property Office, the disclosure of which is incorporated herein by reference.

### BACKGROUND

1. Field of the Invention

The present invention relates to a stream synchronization for an application system that is operated based on an association between a plurality of different kinds of streams in an overlay network, and relates to a stream-related layering method for a community broadcasting.

2. Description of the Related Art

A network infrastructure provides increased transmission/reception speeds and a server resource is developed as a multimedia content-centric service, such as, an Internet protocol TV (IPTV) service, an Internet TV service, and a web TV service, increases. However, a network resource has an ineffective structure to process the multimedia content. As a typical example, there is an IP multicast.

The IP multicast, as one of various methods of routing traffic for a group, may not solve problems such as a lack of an Internet protocol (IP) resource while an Internet protocol version 6 (IPv6) is not widely used, a compatibility problem with existing routers, a multicast group managing problem since a content source is extended to a user, and the like. Accordingly, attention of researchers is focused on a peer-to-peer (P2P) scheme or an overlay multicast.

Particularly, a media contents-centric overlay multicast method using a structure of the existing Internet as a platform and embodying a service or a system on the platform, is used. The method has an advantage of being flexible and having a high efficiency since the method is embodied in an application end, and at the same time, has various problems, such as a complex mutual relationship occurring in a distributed environment, an effect on a lower network based on a service or a contents providing model, a stability of an added service when a user resource is used as the network infrastructure, an equity when a service user provides a resource. Also, there are various problems to overcome, such as synchronization of media contents that is transmitted via various routes, based on a feature of the service. The problems are not solved by a single solution, and have different solutions for each problem based on an approach.

An infrastructure or a service provider may consider an effective use of a network, a server, and the like, important, and a user may more pay attention to a service, such as convenience and responsiveness of the service, various supplemental services, and the like. Generally, the service provider provides a significantly small amount of resources, which is not different from a general user, and thus, the user has low expectation with respect to the service. Conversely, in a hybrid overlay environment providing a portion of a content delivery network (CDN), the user demands a more stable service and expects to receive compensation for its used resource.

A P2P scheme enabling distribution of a file is already recognized, and many service firms do not hesitate to introduce a service based on the P2P or an overlay, and a scheme, such as BitTorrent, is understood as a protocol and is utilized for integrating with another system. However, the P2P may have a limited efficiency depending on a number of users, and thus, the P2P may not be utilized for various services.

As an example, when a purpose of using a corresponding content is ended, the corresponding content may not be always shared, and a route of content may not be efficient based on the P2P when the number of users using the content is not large. Although the P2P has a great power to simultaneously distribute a popular content, the P2P may have problem in reliability and stability when intermittently distributing various media.

The overlay multicast that is a background art in the present invention is more related to providing a multicast more appropriate for a group communication, than to distributing a file, and has an effective structure for a real-time broadcasting or a video conference. However, an amount of operation of each node added for an efficiency of a resource of a network and a structural method for supporting a feature of the service may deteriorate the stability and a feature of a real-time, and thus, the user may experience efficiency deterioration of a system, and there may be difficulty in interoperating with various services and supporting the various service. Accordingly, an issue of the study is simply and effectively reducing a complexity of the mutual relationship between nodes based on a feature and a scale of the corresponding service.

However, compared with an existing client server method, a feature of a real-time with respect to an original main media content and media content of a participatory user may not be guaranteed in the overlay network. In a case of the broadcasting service, the user may ignore the feature of real-time due to a one-way feature, unless there is a great gap in transmission of consecutive contents. However, the media contents-centric bi-directional broadcasting considers the feature of real-time very important.

Accordingly, data transmission tree (or mesh structure) may need to pursue an efficiency of a network, and at the same time, may need to be designed in consideration of a transmission delay. When the overlay multicast method is applied to an existing video conference, a feature of real-time is deteriorated and a complex stream routing process is added.

Thus, a method that enables a user receiving a predetermined media-centric service to make a user's media to effectively be joined without changing a corresponding transmission structure, a method of muxing, demuxing, and managing media to provide the feature of real-time of an interactive media, and a method of effectively managing the transmission structure is desired. Also, a method where only predetermined participants and predetermined groups use data in a corresponding data transmission structure, data transmission to an unrelated user is minimized is desired.

A general overlay multicast creates a data transmission structure per each single media content, as an example, per each broadcasting channel, and when the user intends to broadcast a related corresponding image or to make an image of the user to join, the user may generate another transmission structure that uses itself as a source, and the transmission structure may be extended through a corresponding participant. As an example, users A, B, and C watching channel 1 respectively make channel 2, channel 3, and channel 4, respectively join different users' channels, and respectively make their own overlay data transmission trees. A user watching channel 1 and simply intends to watch channels 2, 3, and 4 without joining channels 2, 3, and 4 may also need to join the corresponding data transmission tree. As described above, the joining by using a separate data transmission tree may be effective while an overlay multicast tree is made, since an efficiency in generating a single tree is maintained due to a new tree structure that is regarded as a different tree.

However, a channel of the user is derived from the channel 1, and different levels of broadcasting group are generated by participants in the channel 1, and thus, there is need of a separate management structure that structurally manages corresponding channels to represent the described relationship. This separate management structure may not be appropriate for a content-centric network management structure. The appropriateness may need to be considered in advance and may also need to be applied to the data transmission tree, so that a complex problem where a tree is again generated and where users are enabled to join again is avoided.

Also, a synchronization between the corresponding generated channels is important since the corresponding generated channels are a group of media having a mutual relationship. The synchronization in time between provided media is a most important thing in an interactive broadcasting and a group broadcasting.

As described above, the overlay multicast, itself, is a relay structure of user nodes, and thus, a feature of real-time is further deteriorated due to a process delay of intermediate nodes and a network delay, as a multicast packet approaches a terminal node from a source. All nodes have a feature of delaying in receiving media content compared with a client server structure, although the nodes have differences in some degree.

However, in a case of a new tree that is constructed as a separate tree and is constructed to be small by the participant, synchronization between an original media data transmission and media reception may not be guaranteed. Also, a group communication broadcasting where a plurality of participants join may have a problem in that all media channel sessions do not provide a service due to a large gap in time.

Also, nodes that join a single media overlay tree need to consider whether the nodes are able to use a wide range of services by determining whether nodes located at a lower depth of a participant node become a root of a new tree, since a shape of the tree indicates a physical network condition in some degree according to a network condition.

Accordingly, a method and apparatus that particularly pays attention to the described points and may provide a group media data transmission tree structuring method that minimizes a damage of the feature of real-time and effectively manages the overlay multicast tree based on a method of muxing/demuxing a corresponding stream with respect to media contents derived from an original data transmission tree, and structurally identifying and managing the same is desired.

### SUMMARY

An aspect of the present invention provides an overlay multicast system and method for a group media transmission application service composed of a multiple stream, which is operated by muxing, under an overlay network that is already created based on a single stream, another related stream with a structure that is already created.

Another aspect of the present invention provides a method of improving transmission efficiency and a service quality of an overlay network by muxing/demuxing a main stream inputted from a parent node and a newly transmitted additional stream and transmitting the muxed/demuxed stream based on a stream correlation at a predetermined node.

According to an aspect of the present invention, there is provided an overlay multicast system for a group media transmission application service composed of a multiple stream, wherein, when an additional stream is newly transmitted to a predetermined node in an overlay network, the overlay multicast system transmitting a plurality of streams in the overlay network generates a multiple stream by muxing a main stream inputted from a parent node and the additional stream based on stream correlation information in the predetermined node, and transmits the generated multiple stream to a child node.

According to an aspect of the present invention, there is provided an overlay multicast method for a group media transmission application service composed of a multiple stream, wherein, when an additional stream is newly transferred to a predetermined node in an overlay network, the overlay multicast method transmitting a plurality of streams in the overlay network generates a multiple stream by muxing a main stream inputted from a parent node and the additional stream based on stream correlation information in the predetermined node, and transmits the generated multiple stream to a child node.

According to an aspect of the present invention, there is provided an overlay multicast method for a group media transmission application service composed of multiple stream, wherein the overlay multicast method includes muxing a main stream inputted from a parents node and an additional stream newly transferred from a node into a single multiple stream based on stream correlation information, and selectively demuxing the main stream or the additional stream from the multiple stream based on the stream correlation information.

Additional aspects, features, and/or advantages of the invention will be set forth in part in the description which follows and, in part, will be apparent from the description, or may be learned by practice of the invention.

### EFFECT

According to an embodiment of the present invention, there is provided an overlay multicast system and method for a group media transmission application service composed of a multiple stream, which is operated by muxing, under an overlay network that is already created based on a single stream, another related stream with a structure that is already created.

According to an embodiment of the present invention, there is provided a method of improving transmission efficiency and a service quality of an overlay network by muxing/demuxing a main stream inputted from a parent node and a newly transferred additional stream, and transmitting the muxed/demuxed stream based on a stream correlation at a predetermined node.

According to an embodiment of the present invention, a bi-directional participatory broadcasting service, a video conference service, or a hierarchical additional contents providing service is possible through maximally utilizing an existing transmission structure in a multiple media-centric group (community) and adding and muxing various and unlimited media of a sub group.

According to an embodiment of the present invention, an existing overlay tree is used as is, and an application service having the same function is minimally changed, thereby effectively using a network and minimizing a complexity of a system for embodying the function.

According to an embodiment of the present invention, interactive participatory streams of users are localized and a plurality of derived services are embodied with a minimum cost and utilized in a broadcasting through a distribution overlay network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an overlay multicast system according to an embodiment of the present invention;

FIG. 2 is a diagram illustrating a transmission flow of a multiple stream according to an embodiment of the present invention;

FIG. 3 is a diagram illustrating an operation of muxing with respect to a multiple stream according to an embodiment of the present invention;

FIG. 4 illustrates an example that a request for a new additional stream is generated in a first node in an overlay network according to an embodiment of the present invention;

FIG. 5 illustrates an example that a root node is selected as a muxing node in an overlay network according to an embodiment of the present invention;

FIG. 6 illustrates an example that an upper node of a first node is selected as a muxing node in an overlay network according to an embodiment of the present invention;

FIG. 7 illustrates an example of changing a muxing node according to a first node that requests a multiple stream according to an embodiment of the present invention;

FIG. 8 is a diagram illustrating a configuration of an overlay network that ignores synchronization between a main stream and an additional stream, according to an embodiment of the present invention;

FIG. 9 is a diagram illustrating a configuration of an overlay network where a partial synchronization between a main stream and an additional stream occurs, according to an embodiment of the present invention;

FIG. 10 is a diagram illustrating a configuration of an overlay network where a complete synchronization between a main stream and an additional stream occurs, according to an embodiment of the present invention; and

FIG. 11 is a flowchart illustrating an overlay multicast method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

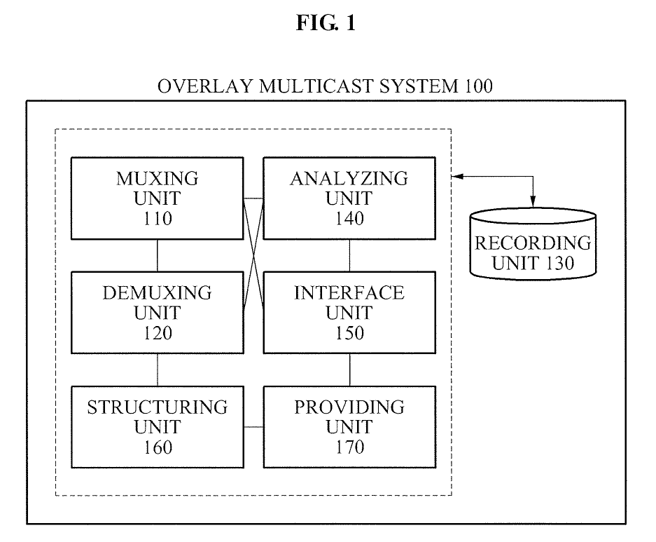

FIG. 1 is a diagram illustrating a configuration of an overlay multicast system according to an embodiment of the present invention.

When an additional stream is newly transferred to a predetermined node in an overlay network, an overlay multicast system 100 for a group media transmission application service composed of a multiple stream performs muxing a main stream inputted from a parent node and the additional stream into a multiple stream based on stream correlation information of the node, and transmits the generated multiple stream to a child node.

Also, the overlay multicast system 110 performs demuxing the additional stream from the multiple stream based on the stream correlation information and transmits the demuxed additional stream to the child node.

Accordingly, in a case of stream transmission for a multimedia broadcasting service, when a new stream is generated from an intermediate node, the present invention performs muxing the generated additional stream and the main stream inputted from the parent node, and transmits the muxed stream, and thus, a transmission delay of each node may be the same. Accordingly, a transmission efficiency of the overlay network and a service quality may be improved.

The overlay multicast system 100 of FIG. 1 may be embodied by an overlay network that is structured by connecting a plurality of nodes as a tree structure or a mesh structure.

The overlay multicast system 100 may include a muxing unit 110 and a demuxing unit 120.

The muxing unit 110 performs muxing the additional stream that is newly transferred from a node and the main stream inputted from the parent node based on the stream correlation information to generate the single multiple stream. That is, when transmission of the additional stream is requested by a participant node while the main stream is transferred from the parent node, the muxing unit 110 receives the additional stream at a corresponding node and performs muxing the received additional stream and the main stream into the multiple stream.

Conversely, the demuxing unit 120 selectively performs demuxing the main stream or the additional stream from the multiple stream. That is, the demuxing unit 120 performs demuxing the multiple stream into the main stream and the additional stream based on the stream correlation information stored in association with the multiple stream.

As an example of demuxing the multiple stream, the demuxing unit 120 recognizes a specific node as a point where to perform demuxing the multiple stream based on the stream correlation information, and performs demuxing the multiple stream into the main stream or the additional stream. As an example, when transmission of the additional stream to a subsequent child node is not requested, the demuxing unit 120 performs based on the stream correlation information, demuxing the additional stream from the multiple stream, and thereby provides an environment where only a stream from which the demuxed additional stream is eliminated is transmitted to the child node.

Conversely, when transmission of the additional stream to the subsequent child node is requested based on the stream correlation information, the overlay multicast system 100 of the present invention omits, demuxing the multiple stream performed by the demuxing unit 120, and thereby provides an environment where a multiple stream including the additional stream is transmitted to the child node.

Here, the stream correlation information may be information determined by a hierarchical structure among unique stream identifiers. In this instance, the hierarchical structure between the stream identifiers may include a dependent relationship between the main stream and the additional stream, and may further include a dependent relationship between the additional stream dependent upon the main stream and another additional stream.

As an example, when the stream is related to the broadcasting system, the unique stream identifier may be a channel or a hash value based on the channel, and when the stream is related to a file service, such as a video on demand (VOD) service, the unique stream identifier may be a file name or a hash value based on the file name.

As a detailed example, the stream correlation information indicates ‘M1(main stream identifier)−M1−1(first additional stream identifier dependent upon M1)−M1−1−1(another additional identifier dependent upon M1−1)’, and represents a correlation between the main stream and the additional stream based on a hierarchical structure of the stream identifiers.

With respect to the stream correlation information, the overlay multicast system 100 may further include a recording unit that records stream correlation information that is created based on a degree of association between the main stream and the additional stream, and an analyzing unit 140.

The recording unit 130 records the degree of association, namely a correlation, between the main stream and the additional stream in a specific area of a multiple stream generated by the muxing unit 110, as the stream correlation information. As another example, the recording unit 130 may record, in a unique storage space, a correlation between the muxed main stream and the additional stream, in response to the generation of the multiple stream.

The analyzing unit 140 may determine whether to perform muxing the main stream and the additional stream into the multiple stream at a corresponding node, or to perform demuxing the additional stream from the multiple stream.

However, according to another embodiment of the present invention, the overlay multicast system 100 may further include an interface unit 150, and the overlay multicast system 100 may transmit, through the interface unit 150, a muxed stream or demuxed stream based on the analyzed stream correlation information to a transmission line set based on a routing policy. That is, the interface unit 150 may determine the transmission line satisfying an optimal quality based on the routing policy when the overlay network is structured, and may transmit, to the determined transmission line, the muxed multiple stream, the main stream demuxed from the multiple stream, or the additional stream demuxed from the multiple stream.

Also, according to another embodiment of the present invention, the overlay multicast system 100 may further include a structuring unit 160 that structures the overlay network by connecting a plurality of nodes as a tree structure or a mesh structure based on a degree of synchronization. That is, the structuring unit 160 may perform grouping by connecting the plurality of nodes as a predetermined tree structure or a predetermined mesh structure, so that streams having correlation are transmitted via the same routing route, and the streams are synchronized. The overlay multicast system 100 may provide, through the structuring unit 160, a group media transmission application service that improves a transmission efficiency of an overlay network and a service quality based on the same transmission delay.

Also, according to another embodiment of the present invention, the overlay multicast system 100 may further include a providing unit 170 to provide at least one of a bi-directional participatory broadcasting service, a video conference service, a community broadcasting service, and a hierarchical additional contents providing service, by using the multiple stream. That is, the providing unit maximally utilizes an existing transmission structure in a multiple media-centric group (community), and performs adding and muxing of media of a sub group that is various and unlimited, and thereby provides an environment where the bi-directional participatory broadcasting service, the video conference service, and the hierarchical additional contents providing service are possible.

As another embodiment of the present invention, the multiple stream includes a peer identifier (PID) related to a number of muxes, and the muxing unit 110 may perform layering and muxing of the main stream and the additional stream.

That is, the multiple stream includes the PID that records the number of muxes, and the muxing unit 110 updates the PID by increasing the PID included in the multiple stream up to a set value, as an example, up to “1”, as the muxing is performed.

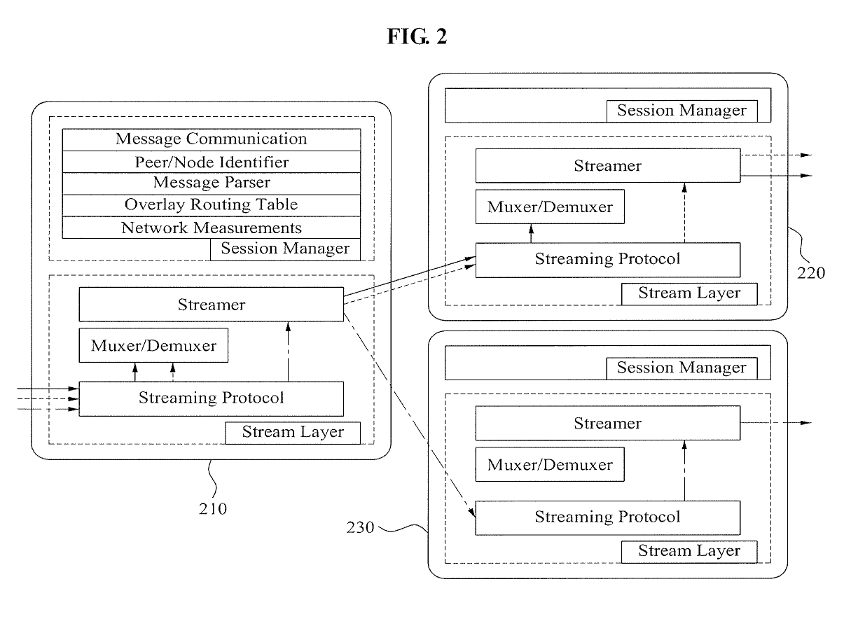

FIG. 2 is a diagram illustrating a transmission flow of a multiple stream according to an embodiment of the present invention.

Each of nodes 210, 220, and 230 constituting an overlay network of FIG. 2 may include a basic transmitting/receiving module, a measuring and controlling module to structure the overlay network, and a module for hierarchically muxing and demuxing media contents.

In this instance, each of the nodes 210, 220, and 230 may not include a mixing module that performs decoding and encoding of the multiple stream. In an overlay multicast constituted by general user nodes, the mixing module may not be proper due to a heavy load.

Although a sufficiently efficient system resource and an encoding/decoding of a high performance codec are supported, system resource capability and codec performance may be main factors that increase a relay delay of a node, and thus, the present invention may use a method of muxing an individual stream. Also, the present invention may include a PID and an identifier to identify the individual stream.

A parent node 210 which receives a muxed multiple stream may transmit different streams to each of child nodes 220 and 230. In other words, the parent node 210 may transmit the received stream as is, that is, two streams muxed into a stream, to the child node 220, and the parent node 210 may perform demuxing of the received stream and transmit the demuxed stream to the child node 230.

This may be related to another child node that regards the corresponding child nodes 220 and 230 as a parent node, namely a request stream of a terminal network side.

In other words, each of the nodes 210, 220, and 230 may distinguish a stream to be transmitted based on a participatory data relationship of the corresponding node, until an end of a tree of a corresponding child node.

When there are a plurality of participant session streams, a layering of the participant streams needs to be represented by a hierarchical structure of the tree

Accordingly, when a stream is muxed with a stream that is already muxed, recognizing whether a relationship between the streams is equal or hierarchical is important to determine a level and an amount of a stream to be dumuxed and to be transmitted to corresponding child nodes.

However, a general media format, as an example, a Moving Picture Experts Group transport stream (Mpeg TS), does not represent the hierarchical relationship, and an existing stream is equally muxed with a new stream, although the existing stream is already muxed.

The muxing/demuxing of the stream in the present invention includes an identifier of an individual stream in a header, or is applied to all methods that use a standard multiple stream container such as a media format.

As an example of the present invention, since the muxing method of the media format does not support a hierarchical muxing in a PES level, the muxing method writes a program ID prepared in the media format as a hierarchical sign and selectively performs demuxing a corresponding PES and a corresponding media format to represent a hierarchical relationship of individual streams to be muxed in the media format

When a stream is demuxed, the corresponding stream may be demuxed by a PID of a header of the media format to not perform demuxing of unnecessary PES, based on a classified method of a data transmission node. The method may be considered to perform muxing/demuxing a stream with a smallest load to each node.

When a multiple stream is muxed in the overlay structuring node, a multiplexer of the media format may not represent a hierarchical relationship between a stream that is once muxed and a stream to be newly muxed. The multiplexer may generate a new stream based on a method similar to a method of demuxing the corresponding stream and muxing with a new stream.

According to an embodiment of the present invention, a corresponding hierarchical structure may be created by only manipulation on a stream without a special manipulation on the corresponding stream, to utilize an existing multiplexer and to support a general standard player of an overlay node.

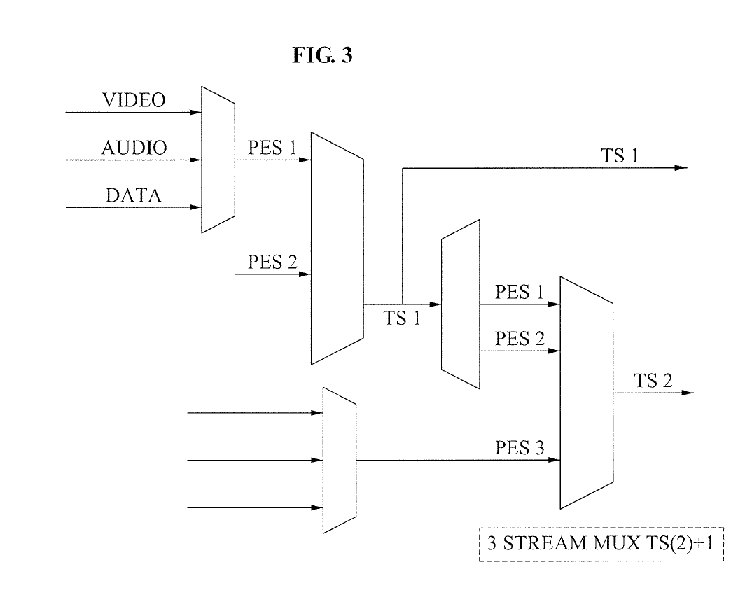

FIG. 3 is a diagram illustrating an operation of muxing a multiple stream according to an embodiment of the present invention.

In a broadcasting system, a video, an audio, and data may be logically treated as a stream. In a media format, the video, the audio, and the data may be the stream. The stream generally has a single ID in the media format, and a plurality of streams are muxed through a muxer and are represented as a single stream.

FIG. 3 illustrates a process of muxing three streams.

First, a PES1 stream and a PES2 stream may be muxed into TS1 that is a single stream. Here, a PES3 may be muxed with TS1 again. Generally, three streams, the PES1, PES2, PES3 streams, are muxed again into TS2.

Accordingly, when demuxing a stream of a corresponding hierarchical structure is performed based on the overlay network, existing internal values of TS may not be used. In other words, whether the stream is generated by muxing TS1 and PES3 may not be known from TS2.

Accordingly, to demux and to drop the corresponding stream based on a network structure, with respect to a participant stream, a data structure of hierarchical information with respect to the structure is needed. The present invention generally represents the data structure through a PID value that is added to a PS constituted by a single PES.

In the media format, the PID is a value included in a 4 byte packet header, is represented in 13 bits, and performs as an identifier of the corresponding stream. In principal, generation of the PID is not limited, excluding 17 reserved PIDs. In an example of the present invention, the first 6 bits of the PID represents a number of muxes performed on the corresponding stream. As an example, the present invention may represent 64 layer structures from 0x00 to 0x3F. When a stream is muxed, the PID is allocated based on the rule, and when a stream is demuxed, only a PID to be dropped is dropped from a corresponding tree structure, and thus, a corresponding hierarchical structure may be represented without affecting any one of Program Specific Information (PSI), Program Association Table (PAT), and Program Map Table (PMT).

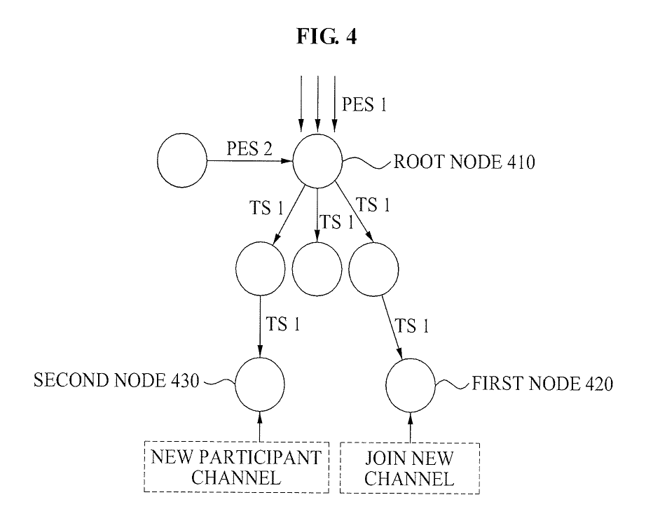

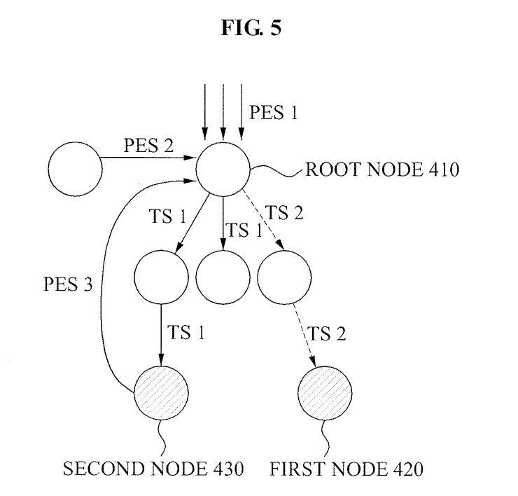

FIG. 4 illustrates an example that a request for a new additional stream is generated in a first node in an overlay network according to an embodiment of the present invention, and FIG. 5 illustrates an example that a root node is selected as a muxing node in an overlay network according to an embodiment of the present invention.

FIG. 4 illustrates an overlay network where all nodes participate in two main stream composed of PES1 and PES2. The root node 410 generates a multiple stream TS1 by muxing the PES1 and the PES2 received from a broadcasting system, and may transmit the multiple stream TS1 to a lower node of the root node 4110.

In this instance, when participation of a new additional stream PES3 occurs in a second node 430 and a first node 420 requests the additional stream PES3, the second node 430 transmits the additional stream PES3 to a third node as shown in FIG. 5, and requests to perform muxing of the multiple stream TS1 and the additional stream PES3 in the third node.

The root node 410 as the third node, may transmit, to an upper node 510, a multiple stream TS2 generated by muxing of the multiple stream TS1 and the additional stream PES2, and the upper node 510 may transmit the received multiple stream TS2 to the first node 420. That is, the first node 420 may check the additional stream PES3 that the first node 420 requests, through the multiple stream TS2.

Also, the root node 410 as the third node, may transmit the multiple stream TS1 to nodes 520 and 530 excluding the first node 420 and the upper node 510 of the first node 420. That is, the root node 410 may perform demuxing of the multiple stream TS2 into the multiple stream TS1 and the additional stream PES3, and may transmit the demuxed multiple stream TS1 to the nodes 520 and 530.

Here, a first 6 bits of a PID of the additional stream PES3 that is newly muxed is 0x02, and thus, PES3 is distinguished as a stream in a second level. The PES1 and the PES2 included in the existing multiple stream TS1 are represented as 0x01, and the root node 410 as the third node, may classify the multiple stream TS1 and the multiple stream TS2 by simply eliminating the additional stream PES3 from the multiple stream TS2.

When an additional stream PES4 is newly muxed with the multiple stream TS2, a first 6 bits of a PID of the additional stream PES4 is 0x03, and a multi stream TS3 is generated by muxing the multiple stream TS2 and the additional stream PES4. The multiple stream TS3 may be decomposed into three states, such as the multiple stream TS1, the multiple stream TS2, and the multiple stream TS3, and a stream drop may be dropped in a form that the streams in three levels are muxed, such as {TS1,TS2},TS3, and TS1,TS2,TS3.

As described above, according to an embodiment of the present invention, a muxing relationship of hierarchical streams are represented in a PID, and thus, a specific node-centric stream community is projected as is on an original overlay network

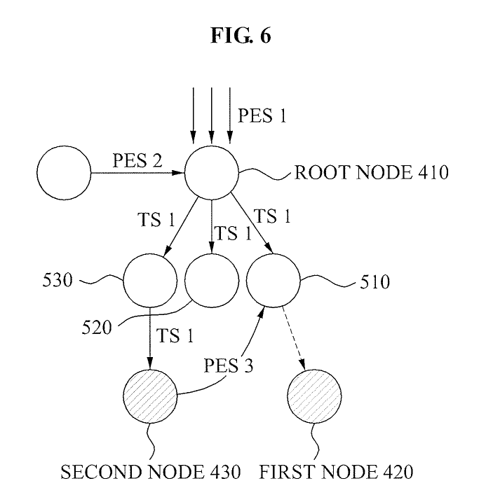

FIG. 6 illustrates an example that an upper node of a first node is selected as a muxing node in an overlay network according to an embodiment of the present invention.

Referring to FIG. 6, when participation of an additional stream PES3 newly occurs in the second node 430 and the first node 420 requests the additional stream PES3, the second node 430 as the third node, may transmit the additional stream PES3 to the parent node 510 of the first node 420. The parent node 510 of the first node 420 performs muxing of the received additional stream PES3 with a multiple stream TS1 and generates a multiple stream TS2, and transmits the generated multiple stream TS2 to the first node 420.

When the muxing is performed through the parent node 510 of the first node 420 as shown in FIG. 6, a traffic load on links to the nodes 520 and 530 which are not related to the muxed multiple stream may be decreased, compared with when muxing is performed through the root node 410 as shown in FIG. 5.

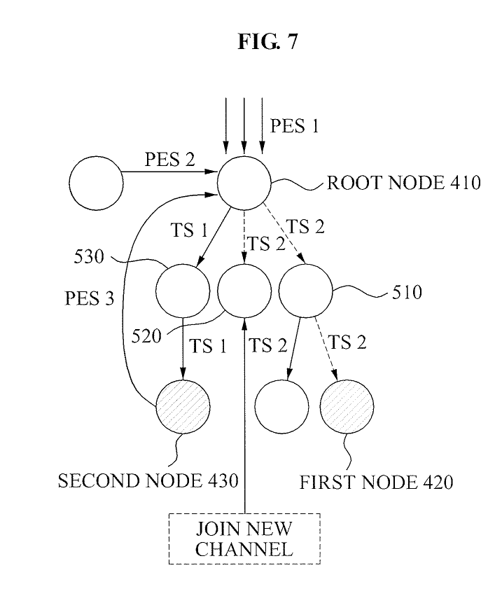

FIG. 7 illustrates an example of changing a muxing node according to a first node that requests a multiple stream according to an embodiment of the present invention.

When muxing is performed through the parent node 510 of the first node 420 as shown in FIG. 6, traffic loaded on links to the nodes 520 and 530 may be minimized. However, when a participant node, namely, the first node 420, is located on an upper layer of a tree, other unrelated nodes performs relaying the muxed multiple stream, and thus, a stream added to a network increases and a transmission node of a stream to be muxed needs to change a muxing node of its stream whenever a new participant node is generated.

That is, an embodiment of the present invention may select a parent node of the participant node as a muxing node, and may change a current muxing node by determining whether the muxing node at a layer higher than the current muxing node.

When the selected muxing node determines request nodes among child nodes of the selected muxing node by a participant stream opener, transmits a stream to the corresponding child nodes, and the selected muxing node receives location information (Degree id, Depth id) from a participant channel opener and performs drop transmission of the stream to the child nodes when the request nodes are lower nodes than the existing muxing node. When a grandchild node or a lower node thereof is a request node, a stream drop may be performed by a simple and consistent method through repeatedly transferring location information of the request node to the child node that is a parent node of the corresponding grand child node

As described above, the present invention may embody a community broadcasting of tree participant nodes by synchronizing an interactive stream of a user with an original stream in an existing network transmission structure, and may be effectively used for utilizing communication tools synchronized with contents, such as an interactive broadcasting, participant broadcasting, a text, and the like.

Here, methods for efficiently using the data transmission overlay tree structure are additionally derived based on the currently structured community information, and one example is using a different tree structuring method based on information about a current derived stream, community group, and the like. Basically, in the method, when a data transmission tree is structured as a depth-priority data transmission tree, a user participant stream minimally affects the original transmission tree. However, an efficiency of the overlay transmission structure may decrease. A trade-off relationship between an efficiency of an entire network and a relative transmission delay (RDP) in a traditional overlay multicast data transmission tree is established. Accordingly, when a parent node candidate list (PPL) that is determined when a new node joins is selected, selection of a degree and depth-priority tree may be variably operated based on a types of current additional stream, a number of communities, and the like.

In the present invention, a multiple stream and an additional stream are synchronized by muxing, and muxed single stream is transmitted, and thus, declinations in broadcasting delay of users based on a depth of an overlay tree are equal. Therefore, the present invention is enormously efficient since the method simply needs to reflect adjustment of performance of a tree based on a time and a location where a node exists.

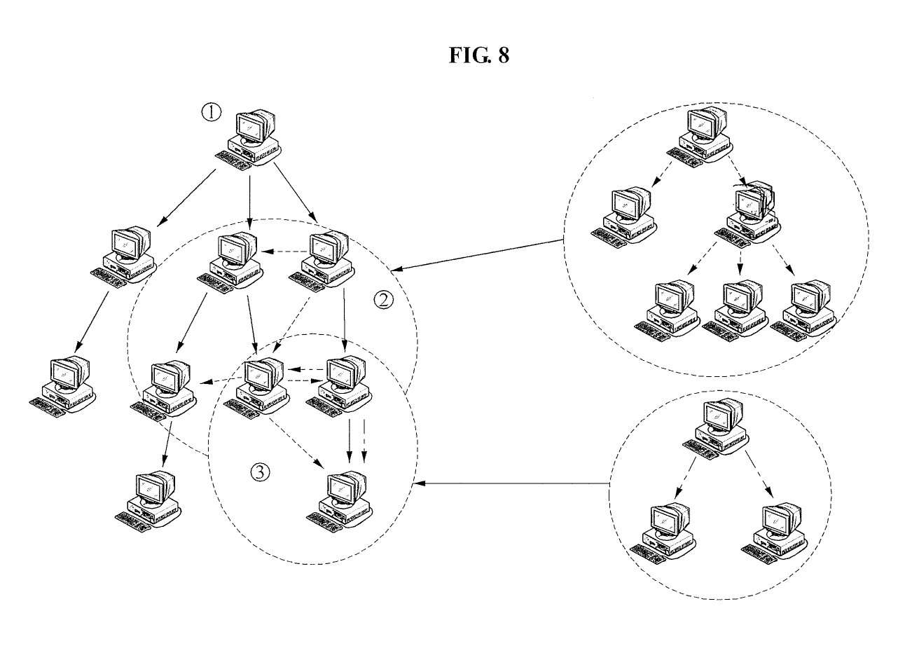

As a method of improving the efficiency, a method of switching a node that is affected by a corresponding participant route may be considered. Generally, the method of switching nodes is not encouraged for a real-time service since a great amount of system overhead is created when changing an overlay network. However, when the synchronization is supported as described in the present invention, the method of switching nodes may be considered to improve the efficiency of the tree. Hereinafter, the node switching will be described with reference to FIGS. 8 to 10.

FIG. 8 is a diagram illustrating a configuration of an overlay network that ignores synchronization between a main stream and an additional stream, according to an embodiment of the present invention.

FIG. 8 illustrates an embodiment that the main stream and the additional stream are structured by different overlay networks from each other. The described method may be used for efficiency of an overlay routing and a network in an application that ignores a request for a synchronization important, as an example a multiple stream transmission that is not a video conference or an interactive broadcasting, namely, an application service, such as a reference image or a reference scene for a viewer.

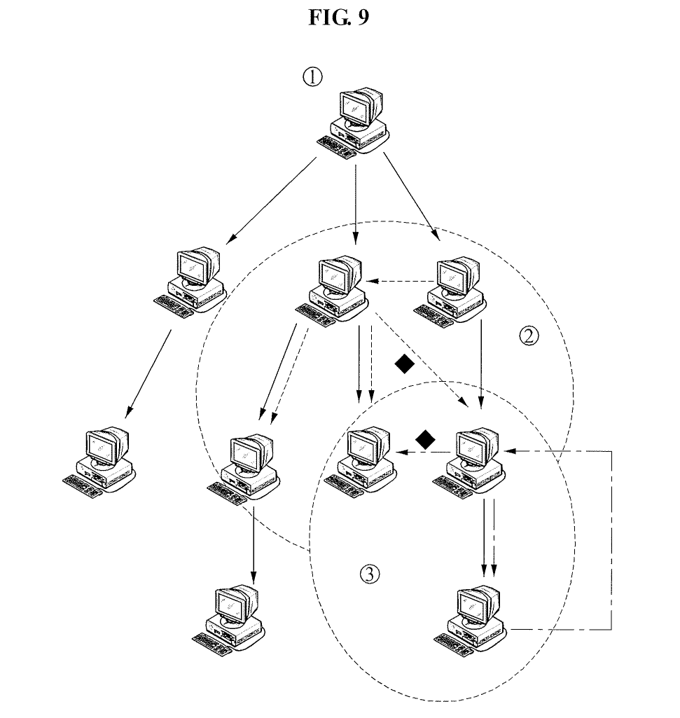

FIG. 9 is a diagram illustrating a configuration of an overlay network where a partial synchronization between a main stream and an additional stream occurs, according to an embodiment of the present invention

FIG. 9 illustrates an embodiment that sub streams in a group are synchronized by adjusting a network based on a method of according the sub streams with a routing structure of an existing main stream for each participant group, and adding a minimum amount of traffic to an upper depth. Although the synchronization with the main stream may be deteriorated to some degree, there is an effect that streams in the group are synchronized to some degree. Although the described method deteriorates synchronization with the main stream or synchronization with the upper stream, there is an effect that a multiple stream in a group of each level is synchronized to some degree. The method may be utilized as an interactive media contents operated regardless of a main contents flow, a communication tool of a community party formed by the media contents, and the like. When the main contents is an application that is sensitive to a real-time and the synchronization, such as a game, a relay from a spot, and the like, the method may be used as a communication channel of users.

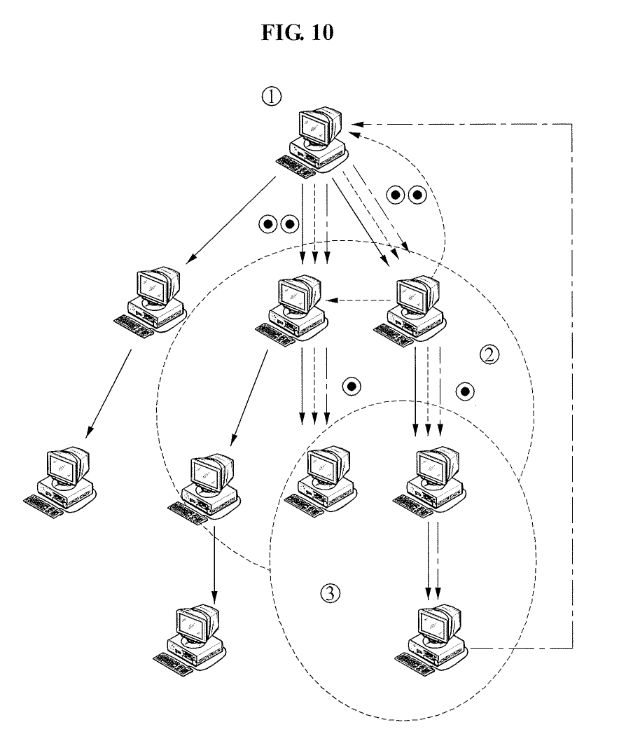

FIG. 10 is a diagram illustrating a configuration of an overlay network where a complete synchronization between a main stream and an additional stream occurs, according to an embodiment of the present invention.

To create the network, a newly requested stream is repeatedly generated through a process of a searching for a common root in a network related to a main stream. In this instance, all streams in the overlay network may be synchronized with the main stream, and all users synchronize the main stream with the additional stream, and thus, a service may be utilized based on the same delay. A synchronization service of almost all bi-directional media contents and tools added to a broadcasting feature is possible.

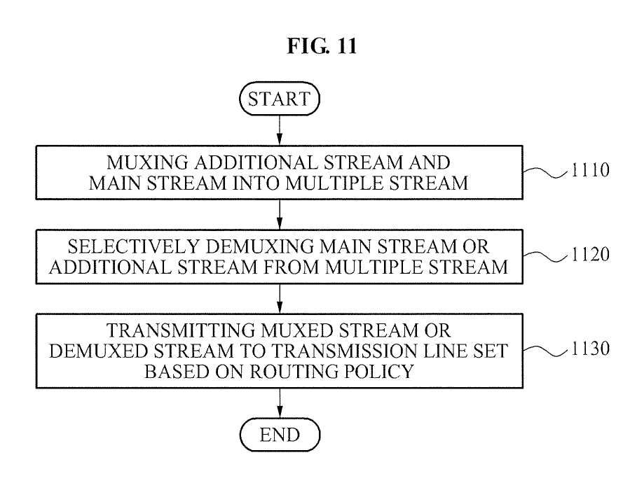

FIG. 11 is a flowchart illustrating an overlay multicast method according to an embodiment of the present invention.

The overlay multicast method may be embodied by the overlay multicast system 100 of FIG. 1. That is, the overlay multicast method may be embodied by a node in an overlay network including the overlay multicast system 100. Hereinafter, the flowchart of FIG. 11 will be described with reference to FIG. 1.

In operation 1110, the overlay multicast system 100 performs muxing a main stream inputted from a parent node and an additional stream newly transferred from a node into a single multiple stream based on stream correlation information. That is, operation 1110 is an operation to generate the multiple stream by receiving the additional stream by a corresponding node when a participant node requests transmission of the additional stream while the main stream is transmitted from the parent node, and muxing the main stream with the received additional stream.

Next, in operation 1120, the overlay multicast system 100 selectively performs demuxing of the main stream or the additional stream from the multiple stream. That is, the operation 1120 is an operation of demuxing of the multiple stream into the main stream and the additional stream based on the stream correlation information stored in association with the multiple stream.

Subsequently, in operation 1130, the overlay multicast system 100 transmits a stream that is muxed or demuxed based on the stream correlation information to a transmission line set based on a routing policy. That is, the operation 1130 is an operation of calculating the transmission line satisfying an optimal quality based on the routing policy while the overlay network is structured, and transmitting the muxed multiple stream, the demuxed main stream, or the demuxed additional stream to the calculated transmission line.

As a method of improving a stream transmission efficiency in the overlay network according to the present invention, a method of switching a node that is affected by a corresponding participant route may be considered. Generally, the method of switching nodes is not encouraged for a real-time service since a great amount of system overhead is created when changing an overlay network. However, when the synchronization is supported as described in the present invention, the method of switching nodes may be considered to improve the efficiency of the tree as described with reference to FIGS. 8 to 10.

The method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An overlay multicast system for a group media transmission application service composed of a multiple stream, wherein, when an additional stream is newly transferred to a predetermined node in an overlay network, the overlay multicast system transmitting a plurality of streams in the overlay network generates a multiple stream by muxing a main stream inputted from a parent node and the additional stream based on stream correlation information in the predetermined node, and transmits the generated multiple stream to a child node.

2. The system of claim 1, wherein, the additional stream is demuxed from the multiple stream based on the stream correlation information and the demuxed additional stream is transmitted to the child node.

3. The system of claim 2, wherein the overlay multicast system comprises:
a muxing unit to perform muxing of the additional stream and the main stream into a single multiple stream; and
a demuxing unit to selectively perform demuxing of the main stream or the additional stream from the multiple stream.

4. The system of claim 2, wherein the overlay multicast system comprises:
a recording unit to record the stream correlation information in the node, the stream correlation information being created based on a degree of association between the main stream and the additional stream; and
an analyzing unit to analyze the recorded stream correlation information.

5. The system of claim 4, further comprising:
an interface unit to transmit a stream that is muxed or demuxed based on the analyzed stream correlation information, to a transmission line set based on a routing policy.

6. The system of claim 3, wherein:
the multiple stream includes a peer identifier (PID) related to a number of muxes, and
the muxing unit performs layering and muxing of the main stream and the additional stream based on the PID.

7. The system of claim 2, wherein the overlay multicast system comprises:
a structuring unit to structure the overlay network by connecting a plurality of nodes as a tree structure or a mesh structure, based on a degree of synchronization.

8. The system of claim 2, further comprising:
a providing unit to provide at least one of a bi-directional participatory broadcasting service, a video conference service, a community broadcasting service, and a hierarchical additional contents providing service, by using the multiple stream.

9. An overlay multicast method for a group media transmission application service composed of a multiple stream, wherein, when an additional stream is newly transferred to a predetermined node in an overlay network, the overlay multicast method transmitting a plurality of streams in the overlay network generates a multiple stream by muxing a main stream inputted from a parent node and the additional stream based on stream correlation information in the predetermined node, and transmits the generated multiple stream to a child node.

10. The method of claim 9, wherein, the additional stream is demuxed from the multiple stream based on the stream correlation information and the demuxed additional stream is transmitted to the child node.

11. An overlay multicast method for a group media transmission application service composed of a multiple stream, wherein the overlay multicast method transmitting a plurality of streams in an overlay network comprises:
muxing a main stream inputted from a parent node and an additional stream newly transferred from a node into a single multiple stream based on stream correlation information; and
selectively demuxing the main stream or the additional stream from the multiple stream based on the stream correlation information.

12. The method of claim 11, further comprising:
recording the stream correlation information that is created based on a degree of association between the main stream and the additional stream; and
analyzing the recorded stream correlation information.

13. The method of claim 12, further comprising:
transmitting a stream that is muxed or demuxed based on the analyzed stream correlation information to a transmission line set based on a routing policy.

14. The method of claim 11, wherein:
the multiple stream includes a PID related to a number of muxes, and
the muxing performs layering and muxing of the main stream and the additional stream based on the PID.

15. The method of claim 11, wherein the overlay multicast system comprises:
structuring the overlay network by connecting a plurality of nodes as a tree structure or a mesh structure, based on a degree of synchronization.

16. The method of claim 11, further comprising:
providing at least one of a bi-directional participatory broadcasting service, a video conference service, a community broadcasting service, and a hierarchical additional contents providing service, by using the multiple stream.
